(19) United States
(12) Patent Application Publication
(10) Pub. No.: US 2026/0307629 A1
(43) Pub. Date: Oct. 8, 2026

(54) DRIVER BRAKING REQUEST SENSOR, MOTORIZED BRAKING APPARATUS, AND METHOD FOR OPERATING AT LEAST ONE DRIVER BRAKING REQUEST SENSOR TOGETHER WITH AT LEAST ONE MOTORIZED BRAKING APPARATUS

(71) Applicant: Robert Bosch GmbH, Stuttgart (DE)

(72) Inventors: Florian Haag, Ellhofen (DE); Markus Schuster, Helmstadt (DE); Martin Marquart, Ludwigsburg (DE); Nikolas Loeffelmann, Dielheim (DE)

(21) Appl. No.: 19/482,125

(22) PCT Filed: Sep. 23, 2024
(86) PCT No.: PCT/EP2024/076594

§ 371 Date: Nov. 6, 2025

(30) Foreign Application Priority Data
Oct. 18, 2023 (DE) 10 2023 210 213.7

(51) Int. Cl. B60T 7/04; B60R 25/045; B60R 25/10; B60R 25/104; B60T 13/74

(52) U.S. Cl. CPC B60T 7/042; B60R 25/045; B60R 25/1001; B60R 25/104; B60T 13/74; B60T 2220/04; B60T 2270/82

(57) ABSTRACT

A driver braking request sensor for a vehicle. The driver braking request sensor includes: a sensor memory unit in which at least one authentication key is stored, and a sensor electronic device by which at least one sensor signal can be output to at least one motorized braking apparatus, in each case in the form of a sensor signal encrypted and/or authenticated with the at least one authentication key. A motorized braking apparatus for a vehicle is also described for cooperating with the at least one driver braking request sensor.

### FIELD

The present invention relates to a driver braking request sensor for a vehicle and to a motorized braking apparatus for a vehicle for cooperation with at least one driver braking request sensor. The present invention also relates to a braking system for a vehicle. Furthermore, the present invention relates to a method for operating at least one driver braking request sensor together with at least one motorized braking apparatus on and/or in a vehicle.

### BACKGROUND INFORMATION

Certain driver braking request sensors and motorized braking apparatuses for cooperating on and/or in a braking system of a vehicle are described in the related art. For example, the braking system described in Germany Patent Application No. DE 10 2021 204 552 A1 describes a rod travel sensor and a differential travel sensor as such driver braking request sensors, and an electromechanical brake booster upstream of a master brake cylinder of the braking system and a pump apparatus with a plurality of pumps as corresponding motorized braking apparatuses.

### SUMMARY

The present invention provides a driver braking request sensor for a vehicle, a motorized braking apparatus for a vehicle, a braking system for a vehicle, and a method for operating at least one driver braking request sensor together with at least one motorized braking apparatus on and/or in a vehicle.

The present invention provides advantageous possibilities for improved cooperation of at least one driver braking request sensor together with at least one motorized braking apparatus on and/or in a braking system of a vehicle. In particular, the present invention empowers the at least one driver braking request sensor to encrypt and/or authenticate an item of information output as the at least one sensor signal by the corresponding driver braking request sensor relating to a (current) actuation of a brake actuation element of the vehicle by its driver. In addition, the present invention enables the at least one motorized braking apparatus to reliably check/verify, based on the encryption and/or authentication of the at least one sensor signal, the authenticity of the at least one sensor signal as a signal actually output by the corresponding driver braking request sensor. The at least one motorized braking apparatus can thus distinguish at least one signal received (as an alleged sensor signal) from a third-party sensor which does not meet the requirements for reliable joint operation together with the corresponding motorized braking apparatus from the at least one encrypted and/or authenticated sensor signal of the at least one driver braking request sensor suitable for cooperation. In this way, it is reliably possible to prevent signals interspersed/manipulated by the third-party sensor, which signals are received by the corresponding motorized braking apparatus, from undesirably impairing its operation/mode of operation. The present invention therefore ensures a more reliable operation of the vehicle equipped with the at least one driver braking request sensor and the at least one motorized braking apparatus.

For example, the driver braking request sensor can be a rod travel sensor, a force sensor or a differential travel sensor. The present invention can thus be used for a sensor type frequently used as a driver braking request sensor.

In an advantageous embodiment of the motorized braking apparatus, the motor control device is additionally designed and/or programmed such that an item of position information relating to a current position of the vehicle can be queried from a position ascertaining apparatus of the vehicle by the motor control device, and a further item of ID information relating to a further authentication key provided to the motorized braking apparatus by an external programming apparatus can only be stored on the memory unit by the motor control device if it is recognized by the motor control device on the basis of the item of position information that the current position of the vehicle is the same as at least one position released for programming the memory unit. This ensures that the embodiment described here of the motorized braking apparatus cannot be manipulated by reprogramming its memory unit.

As an advantageous development of the motorized braking apparatus of the present invention, the motor control device can additionally be designed and/or programmed such that, if a provided signal that is not encrypted and/or authenticated with the at least one authentication key or a predetermined first minimum number of provided signals that are not encrypted and/or authenticated with the at least one authentication key can be recognized by the motor control device, a vehicle start prevention signal can be output to a vehicle engine control apparatus of the vehicle by the motor control device, so that a start of the stationary vehicle is prevented by the vehicle engine control apparatus controlled by the output vehicle start prevention signal. The embodiment of the present invention described here of the motorized braking apparatus can therefore not only recognize the installation of a third-party sensor on the vehicle equipped with the motorized braking apparatus, which sensor does not meet the requirements for joint operation with the motorized braking apparatus, but can also prevent the stationary vehicle from starting if necessary. In this way, the risk of an accident involving the vehicle due to its movement is negligible despite the installation of the third-party sensor.

Alternatively or additionally, the motor control device of the present invention can also be designed and/or programmed in such a way that, if a provided signal that is not encrypted and/or authenticated with the at least one authentication key or a predetermined second minimum number of signals provided that are not encrypted and/or authenticated with the at least one authentication key can be recognized by the motor control device, at least one warning activation signal can be output by the motor control device to at least one warning light device of the vehicle, at least one display device of the vehicle, and/or at least one sound output device of the vehicle. The driver of the vehicle can thus be informed at an early stage of the increased risk of an accident due to the installation of the third-party sensor on his vehicle by a warning light, a flashing warning light, an image display, a word display, a warning tone and/or an announcement.

For example, the motorized braking apparatus can be an electromechanical brake booster that can be mounted upstream of a master brake cylinder of the vehicle, a motorized piston-cylinder apparatus, a pump apparatus, an ABS system or an ESP system. Thus, a variety of commonly used apparatuses can utilize the present invention.

According to an example embodiment of the present invention, a braking system for a vehicle, comprising at least one such driver braking request sensor and at least one corresponding motorized braking apparatus also realizes the advantages described above. If the braking system comprises a first driver braking request sensor and a second driver braking request sensor as the at least one driver braking request sensor, and a first motorized braking apparatus and a second motorized braking apparatus as the at least one motorized braking apparatus, then preferably a first authentication key is stored on the first sensor memory unit of the first driver braking request sensor, a second authentication key is stored on the second sensor memory unit of the second driver braking request sensor, a first item of ID information relating to the first authentication key, and a second item of ID information relating to the second authentication key are stored on the first memory unit of the first motorized braking apparatus, and the same or a different first item of ID information relating to the first authentication key and the same or a different second item of ID information relating to the second authentication key are stored on the second memory unit of the second motorized braking apparatus.

Furthermore, according to an example embodiment of the present invention, carrying out a corresponding method for operating at least one driver braking request sensor together with at least one motorized braking apparatus on and/or in a vehicle also provides the advantages explained above. It is expressly pointed out that the method can be further developed according to the above-described embodiments of the driver braking request sensor and/or of the motorized braking apparatus.

### BRIEF DESCRIPTION OF THE DRAWINGS

Further features and advantages of the present invention will be explained in the following with reference to the figures.

FIG. 1 is a schematic representation of embodiments of the driver braking request sensor and the motorized braking apparatus, according to the present invention.

FIG. 2 is a flow diagram for explaining an example embodiment of the method of the present invention for operating at least one driver braking request sensor together with at least one motorized braking apparatus on and/or in a vehicle.

### DETAILED DESCRIPTION OF EXAMPLE EMBODIMENTS

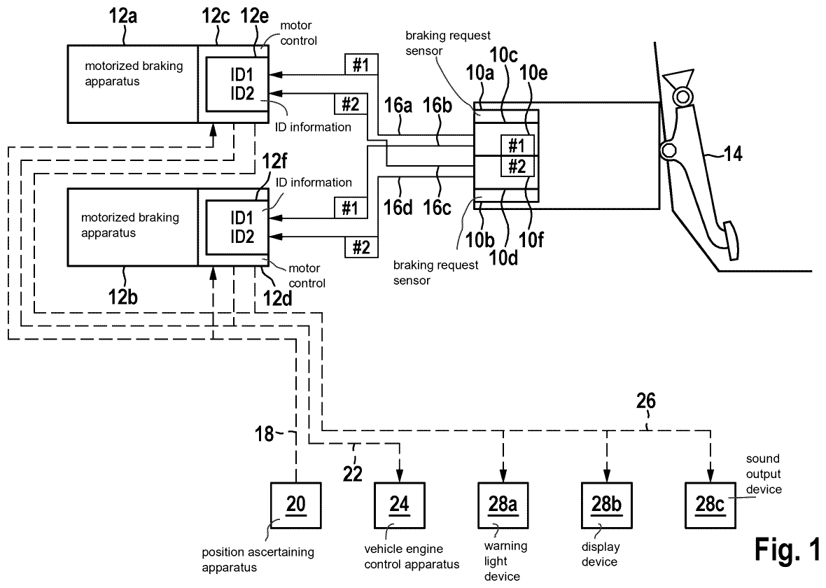

FIG. 1 is a schematic representation of embodiments of the driver braking request sensor and the motorized braking apparatus.

The braking system (shown only partially in FIG. 1) of a vehicle/motor vehicle (not shown) comprises at least one driver braking request sensor 10a and 10b and at least one motorized braking apparatus 12a and 12b. It is to be noted that the braking system does not refer to a specific type of braking system. Instead, the at least one driver braking request sensor 10a and 10b and the at least one motorized braking apparatus 12a and 12b can be installed on and/or in multiple different braking system types. Furthermore, the usability of the braking system, or of the at least one driver braking request sensor 10a and 10b and of the at least one motorized braking apparatus 12a and 12b, is not limited to any specific vehicle type/motor vehicle type of the vehicle/motor vehicle equipped therewith.

The at least one driver braking request sensor 10a and 10b is to be understood in each case as a sensor type by which an actuation of a brake actuation element 14 of the vehicle by its driver can be recognized. For this purpose, the at least one driver braking request sensor 10a and 10b each comprise a (separate) sensor electronic device 10c or 10d, which is designed and/or programmed such that at least one sensor variable relating to a (current) actuation of the brake actuation element 14 can be ascertained/is ascertained. In addition, at least one sensor signal 16a to 16d corresponding to the at least one (self-ascertained) sensor variable can be/is output to the at least one motorized braking apparatus 12a and 12b of the vehicle by the corresponding sensor electronic device 10c or 10d of the at least one driver braking request sensor 10a and 10b. As can be seen in FIG. 1, the brake actuation element 14 can be, for example, a brake pedal 14 of the vehicle. The at least one driver braking request sensor 10a and 10b can in particular be a rod travel sensor 10a, a force sensor and/or a differential travel sensor 10b. Accordingly, the at least one sensor variable can be, for example, a rod travel, a driver braking force and/or a differential travel.

The at least one driver braking request sensor 10a and 10b also comprises in each case a (separate) sensor memory unit 10e and 10f on which at least one authentication key #1 and #2 is stored. The at least one stored authentication key #1 and #2 can be understood in particular as an authentication number. In addition, each of the sensor electronic devices 10c or 10d of the at least one driver braking request sensor 10a and 10b is also designed and/or programmed such that the at least one sensor signal 16a to 16d output by the corresponding driver braking request sensor 10a or 10b can be output to the at least one motorized braking apparatus 12a and 12b of the vehicle as a sensor signal 16a to 16d encrypted and/or authenticated with the at least one authentication key #1 and #2 stored on the associated sensor memory unit 10e or 10f.

The at least one motorized braking apparatus 12a and 12b of the braking system of FIG. 1 is to be understood as an apparatus comprising in each case a (separate) motor and a (separate) motor control device 12c or 12d for controlling its motor. Since suitable motor types are conventional for motorized braking apparatuses 12a and 12b, a pictorial representation of the motor of each of the at least one motorized braking apparatus 12a and 12b in FIG. 1 is omitted. The at least one motorized braking apparatus 12a and 12b of the braking system schematically illustrated in FIG. 1 can be, for example, an electromechanical brake booster 12a that can be or is positioned upstream of a master brake cylinder (not shown) of the braking system/vehicle, a pump apparatus 12b with at least one pump that can be/is operated by a motor of the pump apparatus 12b, an ABS system (anti-lock braking system), an ESP system (vehicle dynamics control system) and/or a motorized piston-cylinder apparatus. A DPB (Decoupled Power Brake) apparatus and/or an IPB (Integrated Power Brake) apparatus can be used as the motorized piston-cylinder apparatus. However, the examples listed here for the at least one motorized braking apparatus 12a and 12b are to be interpreted only as examples.

In addition to its corresponding motor and its corresponding motor control device 12c or 12d, the at least one motorized braking apparatus 12a and 12b comprises in each case a (separate) memory unit 12e or 12f on which is stored at least one item of ID information ID1 and ID2 relating to the at least one authentication key #1 and #2 stored on the corresponding sensor memory unit 10e or 10f of the at least one cooperating driver braking request sensor 10a and 10b. The at least one item of ID information ID1 and ID2 can be, for example, the corresponding stored authentication key #1 and #2 or comparison information corresponding to the stored authentication key #1 and #2.

The corresponding motor control device 12c or 12d of the at least one motorized braking apparatus 12a and 12b is therefore also designed and/or programmed such that it can be ascertained by the corresponding motor control device 12c or 12d, taking into account the at least one item of ID information ID1 and ID2 stored on its memory unit 12e or 12f, whether at least one signal (as an alleged sensor signal 16a to 16d) provided to the corresponding motorized braking apparatus 12a or 12b is encrypted and/or authenticated with the at least one stored authentication key #1 and #2. In addition, each motor control device 12c or 12d of the at least one motorized braking apparatus 12a and 12b is designed and/or programmed such that the motor of the corresponding motorized braking apparatus 12a or 12b is controlled by the associated motor control device 12c or 12d, taking into account the at least one provided signal, only if the at least one provided signal is encrypted and/or authenticated with the at least one authentication key #1 and #2. If, on the other hand, the at least one provided signal is unencrypted and/or unauthenticated, or if the authentication key #1 and #2 used for this purpose deviates from the at least one item of ID information ID1 and ID2 stored on the corresponding memory unit 12e or 12f, a signal content of the at least one affected signal is not used by the corresponding motor control device 12c or 12d to control the associated motor. The recognition of at least one unencrypted and/or unauthenticated signal, or of at least one incorrectly encrypted and/or incorrectly authenticated signal, may also trigger a degradation of the corresponding motorized braking apparatus 12a or 12b and/or a transfer of at least one of its functions to a replacement component.

The advantageous design/programming of each motor control device 12c or 12d of the at least one motorized braking apparatus 12a and 12b and their equipping with their corresponding memory unit 12e and 12f in each case therefore enable a plausibility check by which it can be ensured that only the at least one sensor signal 16a to 16d of the at least one driver braking request sensor 10a and 10b suitable for joint operation is taken into account when controlling the corresponding motor of the corresponding motorized braking apparatus 12a or 12b. The decryption and/or authentication of the received sensor signals 16a to 16d by the receiving motorized braking apparatus 12a or 12b is carried out continuously and without being impaired by the current driving operation of the vehicle. In this way, each motorized braking apparatus 12a and 12b, or its corresponding motor control device 12c or 12d, is able to check whether the at least one signal received by the corresponding motorized braking apparatus 12a or 12b (as alleged sensor signal 16a to 16d) is actually output by the at least one desired driver braking request sensor 10 and 10b. The at least one motorized braking apparatus 12a and 12b thus recognizes as such a signal output to the corresponding motorized braking apparatus 12a or 12b by a third-party sensor which is not suitable for advantageous cooperation with the corresponding motorized braking apparatus 12a and 12b, so that the signal of the third-party sensor does not impair/manipulate an operation of the corresponding motorized braking apparatus 12a or 12b.

The braking system described here, with its at least one driver braking request sensor 10a and 10b and its at least one motorized braking apparatus 12a and 12b, therefore comprises components which are optimized such that replacing the at least one driver braking request sensor 10a and 10b with a third-party sensor cannot lead to any impairment/manipulation of the operation of the at least one motorized braking apparatus 12a and 12b. This eliminates a conventional risk of an accident in the vehicle equipped with the braking system shown in FIG. 1. Equipping the vehicle with the braking system shown in FIG. 1 therefore increases its safety standard.

The corresponding motor control device 12c or 12d of the at Least one motorized braking apparatus 12a and 12b is preferably also designed and/or programmed such that an item of position information 18 relating to a current position of the vehicle can be queried from a position ascertaining apparatus 20 of the vehicle by the corresponding motor control device 12c or 12d. The position ascertaining apparatus 20 of the vehicle can in particular be a GPS system whose GPS data can be/are queried as the position information 18 by the corresponding motor control device 12c or 12d of the at least one motorized braking apparatus 12a and 12b. The requested item of position information 18 can then be used as a “protection mechanism” by the corresponding motorized braking apparatus 12a or 12b to prevent “unauthorized” programming of its memory unit 12e or 12f. For this purpose, the corresponding motor control device 12c or 12d of the at least one motorized braking apparatus 12a and 12b is preferably designed and/or programmed in such a way that a further item of ID information relating to a further authentication key #1 and #2 provided to the corresponding motorized braking apparatus 12a or 12b by an external programming apparatus can be/is stored on the associated memory unit 12e or 12f by the corresponding motor control device 12c or 12d only if it is/can be recognized by the motor control device 12c or 12d, based on the position information 18, that the current position of the vehicle is the same as at least one position released for programming the corresponding memory unit 12e or 12f. The at least one position released for programming the corresponding memory unit 12e or 12f can be understood for example as one position from at least one selected production plant and/or one position from at least one selected auto repair shop. In this way, it can be ensured that programming of the corresponding memory unit 12e and 12f of the at least one motorized braking apparatus 12a and 12b is only carried out by a specialist of the at least one production plant and/or the at least one auto repair shop. However, a person without specialist knowledge cannot, or can hardly, manipulate the memory units 12e and 12f of the at least one motorized braking apparatus 12a and 12b by reprogramming them.

In an alternative embodiment of the at least one motorized braking apparatus 12a and 12b, each motor control device 12c or 12d can also be designed/programmed to use cyber security measures to prevent programming of the associated memory unit 12e or 12f. For example, in this case, each motor control device 12c or 12d of the at least one motorized braking apparatus 12a and 12b is designed and/or programmed such that only data read in via a serial interface to at least one predetermined server are stored as a further item of ID information relating to a further authentication key on the associated memory unit 12e or 12f. This also prevents manipulation of the at least one motorized braking apparatus 12a and 12b by a calibration routine executed by an unauthorized person or a diagnostic command executed by the unauthorized person.

As an advantageous development of the at least one motorized braking apparatus 12a and 12b, each of its corresponding motor control devices 12c or 12d can additionally be designed and/or programmed such that, if a provided signal that is not encrypted and/or authenticated with the at least one authentication key #1 and #2, or a predetermined first minimum number of provided signals that are not encrypted and/or authenticated with the at least one authentication key #1 and #2, is/can be recognized by the motor control device 12c or 12d, a vehicle start prevention signal 22 can be/is output to a vehicle engine control apparatus 24 of the vehicle as a response by the motor control device 12c or 12d. If necessary, the vehicle engine control apparatus 24 of the vehicle is designed/programmed in such a way that a start of the stationary vehicle is prevented by the vehicle engine control apparatus 24 controlled by the output vehicle start prevention signal 22. The vehicle engine control apparatus 24 can be understood as, for example, a central vehicle control of the vehicle, a central control unit of the vehicle, an electric motor control that controls an electric drive motor of the vehicle, or a control apparatus that controls a fuel injection apparatus of the vehicle equipped with an internal combustion engine.

Alternatively or additionally, the corresponding motor control device 12c and 12d of the at least one motorized braking apparatus 12a and 12b can also be further developed such that, if a provided signal that is not encrypted and/or authenticated with the at least one authentication key #1 and #2 or a predetermined second minimum number of provided signals that are not encrypted and/or authenticated with the at least one authentication key #1 and #2 can be/is recognized by the motor control device 12c or 12d, at least one warning activation signal 26 can be/is output by the motor control device 12c or 12d to at least one warning light device 28a of the vehicle, at least one display device 28b of the vehicle and/or at least one sound output device 28c of the vehicle. Using the at least one warning activation signal 26, a lighting and/or flashing of the at least one warning light device 28a, at least one image display and/or at least one word display on the at least one display device 28b and/or at least one warning tone and/or announcement emitted by the at least one sound output device 28c can then be activated, whereby the driver of the vehicle can be informed of the increased risk of an accident due to the installation of the third-party sensor on his vehicle.

In the example of FIG. 1, the illustrated braking system comprises exactly two driver braking request sensors 10a and 10b, i.e. the rod travel sensor 10a and the differential travel sensor 10b. The two driver braking request sensors 10a and 12b are part of an ePedal 30, which also includes the brake actuation element 14 designed as a brake pedal 14. The driver braking request sensors 10a and 10b cooperate with exactly two motorized braking apparatuses 12a and 12b, which are an electromechanical brake booster 12a and a pump apparatus 12b. It can be seen from FIG. 1 that a first authentication key #1 is stored on the first sensor memory unit 10e of the first driver braking request sensor 10a and a second authentication key #2, which differs from the first authentication key #1, is stored on the second sensor memory unit 10f of the second driver braking request sensor 10b. The first driver braking request sensor 10a outputs its sensor signals 16a and 16b, encrypted and/or authenticated with the first authentication key #1, to both the first motorized braking apparatus 12a and the second motorized braking apparatus 12b. The second driver braking request sensor 10b also outputs its sensor signals 16c and 16d, which are encrypted and/or authenticated with the second authentication key #2, to both the first motorized braking apparatus 12a and the second motorized braking apparatus 12b. Therefore, a first item of ID information ID1 relating to the first authentication key #1 and a second item of ID information ID2 relating to the second authentication key #2 are stored on the first memory unit 12e of the first motorized braking apparatus 12a. Also, the Same or a different first item of ID information ID1 relating to the first authentication key #1 and the same or a different second item of ID information ID2 relating to the second authentication key #2 are stored on the second memory unit 12f of the second motorized braking apparatus 12b. Thus, different “authentication signals” can be output from the two driver braking request sensors 10a and 10b as their sensor signals 16a to 16d to each of the two motorized braking apparatuses 12a and 12b, wherein each of the two motorized braking apparatuses 12a and 12b can check the plausibility of the different authentication signals.

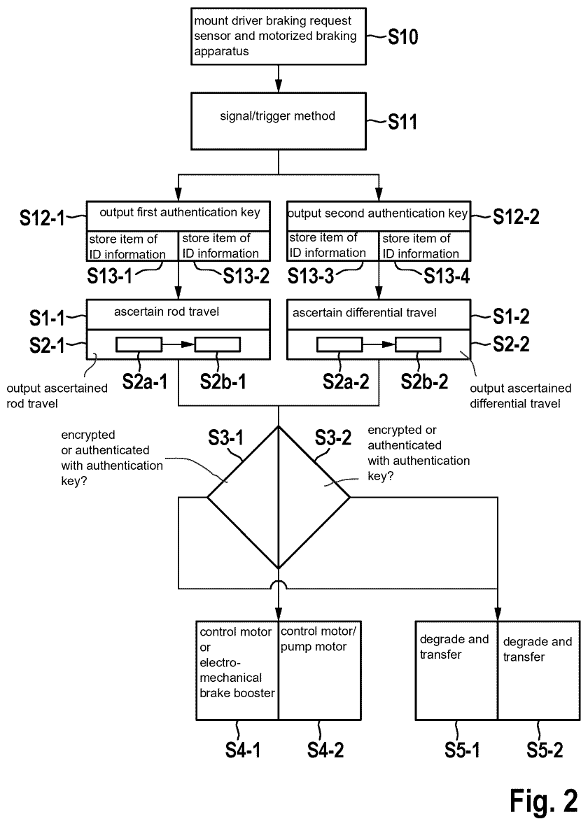

FIG. 2 is a flow diagram explaining an embodiment of the method for operating at least one driver braking request sensor together with at least one motorized braking apparatus on and/or in a vehicle.

The feasibility of the method described in the following is not limited to any specific vehicle type/motor vehicle type of the vehicle/motor vehicle. Furthermore, the feasibility of the method does not depend on the vehicle/motor vehicle being equipped with particular additional braking system components.

The method described below comprises at least one method step S1-1 and S1-2, which is carried out by a corresponding sensor electronic device of the at least one driver braking request sensor. In method step S1-1 or S1-2, at least one sensor variable is ascertained relating to a (current) actuation of a brake actuation element of the vehicle by its driver. By way of example, in the embodiment of the method described here, a rod travel is ascertained in method step S1-1 by the corresponding sensor electronic device of a first driver braking request sensor designed as a rod travel sensor, and a differential travel is ascertained in method step S1-2 by the corresponding sensor electronic device of a second driver braking request sensor designed as a differential travel sensor.

In at least one further method step S2-1 and S2-2, at least one sensor signal corresponding to the at least one sensor variable is output to the at least one motorized braking apparatus by the corresponding sensor electronic device of the at least one driver braking request sensor. In the embodiment described here, therefore, in method step S2-1, the rod travel sensor outputs the ascertained rod travel via its at least one sensor signal, and in method step S2-2, the differential travel sensor outputs the ascertained differential travel via its at least one sensor signal, to the at least one motorized braking apparatus. In addition, in a corresponding sub-step S2a-1 or S2a-2 of the at least one method step S2-1 and S2-2, the at least one sensor signal is encrypted and/or authenticated before its output by the corresponding sensor electronic device of the at least one driver braking request sensor by means of at least one authentication key stored on a sensor memory unit of the same driver braking request sensor. In a further sub-step S2b-1 or S2b-2 of the at least one method step S2-1 and S2-2, the at least one sensor signal is then output to the at least one motorized braking apparatus as a sensor signal encrypted and/or authenticated with the at least one authentication key.

After outputting the at least one sensor signal to the corresponding motorized braking apparatus (by carrying out method step S2-1 or S2-2), a corresponding motor control device of the at least one motorized braking apparatus carries out at least one further method step S3-1 or S3-2, in which it is checked whether the at least one signal provided to the corresponding motorized braking apparatus (as an alleged sensor signal) is actually output by the single driver braking request sensor or by at least one of the driver braking request sensors of the braking system. In method step S3-1 or S3-2, the corresponding motor control device ascertains, taking into account at least one item of ID information stored on a memory unit of the same motorized braking apparatus relating to the at least one authentication key stored on the corresponding sensor memory unit of the at least one driver braking request sensor, whether the at least one signal provided to the corresponding motorized braking apparatus (as an alleged sensor signal) is encrypted and/or authenticated with the at least one authentication key. In the embodiment of FIG. 2, the braking system comprises, as the at least one motorized braking apparatus, an electromechanical brake booster and a pump apparatus with at least one pump operable by its motor. Therefore, in method step S3-1, the motor control device of the electromechanical brake booster ascertains whether the at least one signal provided to the electromechanical brake booster is encrypted and/or authenticated with the at least one authentication key. Accordingly, in method step S3-2, the motor control device of the pump apparatus ascertains whether the at least one signal provided to the pump apparatus is encrypted and/or authenticated with the at least one authentication key.

Only if it is recognized in the corresponding method step S3-1 or S3-2 that the at least one signal provided to the corresponding motorized braking apparatus is actually encrypted and/or authenticated with the at least one authentication key is a corresponding motor of the corresponding motorized braking apparatus subsequently controlled by the associated motor control device as method step S4-1 or S4-2, taking into account the at least one signal provided to the corresponding motorized braking apparatus. Thus, in method step S4-1, the motor of the electromechanical brake booster is controlled, taking into account the at least one signal provided to the electromechanical brake booster, while in method step S4-2, when controlling the motor/pump motor of the pump apparatus, the at least one signal provided to the pump apparatus is taken into account. However, if it is determined when carrying out the corresponding method step S3-1 or S3-2 that the at least one signal provided to the corresponding motorized braking apparatus is not encrypted and/or authenticated with the at least one authentication key, a degradation of the corresponding motorized braking apparatus and a transfer of its function to a backup braking system can take place in at least one (optional) method step S5-1 or S5-2. In this way, carrying out the method described herein also provides the advantages explained above.

As an optional further development, before carrying out the method described here the following method steps can be carried out in order to design/program the braking system to carry out the method steps explained above:

In an (optional) method step S10, the at least one driver braking request sensor and the at least one motorized braking apparatus can be mounted on and/or in the corresponding vehicle. In a further (optional) method step S11, the completed installation of the at least one driver braking request sensor and the at least one motorized braking apparatus can be signaled. Method step S11 can then trigger at least one (optional) method step S12-1 and S12-2, which is carried out by the corresponding sensor electronic device of the at least one driver braking request sensor, in which step the at least one sensor electronic device outputs the at least one authentication key stored on the sensor memory unit of the same driver braking request sensor to the at least one motorized braking apparatus. For example, in method step S12-1, the rod travel sensor can output its first authentication key to both the electromechanical brake booster and to the pump apparatus. Accordingly, in method step S12-2, the differential travel sensor can output its second authentication key to the electromechanical brake booster and to the pump apparatus. In at least one further (optional) method step S13-1 to S13-4, the corresponding motor control device of the at least one motorized braking apparatus then stores the at least one received authentication key, or an item of information/comparison information derived therefrom, as an item of ID information on the memory unit of the same motorized braking apparatus. In the method described here, the motor control device of the electromechanical brake booster therefore stores, in method step S13-1, the item of ID information transmitted via the first authentication key output by the rod travel sensor and, in method step S13-3, the item of ID information transmitted via the second authentication key output by the differential travel sensor, on the memory unit of the electromechanical brake booster. Accordingly, the motor control device of the pump apparatus stores, in method step S13-2, the item of ID information transmitted via the first authentication key output by the rod travel sensor and, in method step S13-4, the item of ID information transmitted via the second authentication key output by the differential travel sensor, on the memory unit of the pump apparatus.

1-10. (canceled)

11. A driver braking request sensor for a vehicle, comprising:
a sensor electronic device configured in such a way that, using the sensor electronic device, at least one sensor variable relating to an actuation of a brake actuation element of the vehicle by its driver can be ascertained and at least one sensor signal corresponding to the at least one sensor variable can be output to at least one motorized braking apparatus of the vehicle; and
a sensor memory unit on which at least one authentication key is stored;
wherein the sensor electronic device is additionally configured in such a way that, using the sensor electronic device, each of the at least one sensor signal can be output to the at least one motorized braking apparatus as a sensor signal encrypted and/or authenticated with the at least one authentication key.

12. The driver braking request sensor according to claim 11, wherein the driver braking request sensor is a rod travel sensor or a force sensor or a differential travel sensor.

13. A motorized braking apparatus for a vehicle for cooperation with at least one driver braking request sensor, the at least one driver braking request sensor including:
a sensor electronic device configured in such a way that, using the sensor electronic device, at least one sensor variable relating to an actuation of a brake actuation element of the vehicle by its driver can be ascertained and at least one sensor signal corresponding to the at least one sensor variable can be output to the motorized braking apparatus of the vehicle, and
a sensor memory unit on which at least one authentication key is stored,
wherein the sensor electronic device is additionally configured in such a way that, using the sensor electronic device, each of the at least one sensor signal can be output to the motorized braking apparatus as a sensor signal encrypted and/or authenticated with the at least one authentication key;
the motorized braking apparatus comprising:
a motor control device configured such that a motor of the motorized braking apparatus can be controlled by the motor control device;
a memory unit on which at least one item of ID information relating to the at least one authentication key stored on the sensor memory unit of the at least one driver braking request sensor is stored;
wherein the motor control device is configured in such a way that the motor control device can ascertain, taking into account the at least one item of stored ID information, whether each of the at least one signal provided to the motorized braking apparatus is encrypted and/or authenticated with the at least one authentication key, and the motor of the motorized braking apparatus is controlled by the motor control device, taking into account the at least one provided signal, only if the at least one provided signal is encrypted and/or authenticated with the at least one authentication key.

14. The motorized braking apparatus according to claim 13, wherein the motor control device is additionally configured such that an item of position information relating to a current position of the vehicle can be queried from a position ascertaining apparatus of the vehicle by the motor control device, and a further item of ID information relating to a further authentication key, provided to the motorized braking apparatus by an external programming apparatus, can only be stored on the memory unit by the motor control device if it can be recognized by the motor control device, based on the item of position information, that the current position of the vehicle is the same as at least one position released for programming the memory unit.

15. The motorized braking apparatus according to claim 13, wherein the motor control device is additionally configured such that, if a provided signal that is not encrypted and/or authenticated with the at least one authentication key or a predetermined first minimum number of provided signals that are not encrypted and/or authenticated with the at least one authentication key can be recognized by the motor control device, a vehicle start prevention signal can be output to a vehicle engine control apparatus of the vehicle by the motor control device, so that a start of the stationary vehicle is prevented by the vehicle engine control apparatus controlled by the output vehicle start prevention signal.

16. The motorized braking apparatus according to claim 13, wherein the motor control device is additionally designed and/or programmed such that, if a provided signal that is not encrypted and/or authenticated with the at least one authentication key or a predetermined second minimum number of provided signals that are not encrypted and/or authenticated with the at least one authentication key can be recognized by the motor control device, at least one warning activation signal can be output by the motor control device to” at least one warning light device of the vehicle and/or at least one display device of the vehicle and/or at least one sound output device of the vehicle.

17. The motorized braking apparatus according to claim 13, wherein the motorized braking apparatus is an electromechanical brake booster which can be arranged upstream of a master brake cylinder of the vehicle or a motorized piston-cylinder apparatus or a pump apparatus or an anti-lock braking (ABS) system or an ESP system.

18. A braking system for a vehicle, comprising:
at least one driver braking request sensor, including:
a sensor electronic device configured in such a way that, using the sensor electronic device, at least one sensor variable relating to an actuation of a brake actuation element of the vehicle by its driver can be ascertained and at least one sensor signal corresponding to the at least one sensor variable can be output to at least one motorized braking apparatus of the vehicle, and
a sensor memory unit on which at least one authentication key is stored,
wherein the sensor electronic device is additionally configured in such a way that, using the sensor electronic device, each of the at least one sensor signal can be output to the at least one motorized braking apparatus as a sensor signal encrypted and/or authenticated with the at least one authentication key; and
the at least one motorized braking apparatus, including:
a motor control device configured such that a motor of the motorized braking apparatus can be controlled by the motor control device,
a memory unit on which at least one item of ID information relating to the at least one authentication key stored on the sensor memory unit of the at least one driver braking request sensor is stored,
wherein the motor control device is configured in such a way that the motor control device can ascertain, taking into account the at least one item of stored ID information, whether each of the at least one signal provided to the motorized braking apparatus is encrypted and/or authenticated with the at least one authentication key, and the motor of the motorized braking apparatus is controlled by the motor control device, taking into account the at least one provided signal, only if the at least one provided signal is encrypted and/or authenticated with the at least one authentication key.

19. The braking system according to claim 18, wherein the at least one driver braking request sensor includes a first driver braking request sensor and a second driver braking request sensor, and the at least one motorized braking apparatus includes a first motorized braking apparatus and a second motorized braking apparatus, and wherein a first authentication key a is stored on a first sensor memory unit of the first driver braking request sensor, a second authentication key is stored on a second sensor memory unit of the second driver braking request sensor, a first item of ID information relating to the first authentication key and a second item of ID information relating to the second authentication key are stored on a first memory unit of the first motorized braking apparatus, and the same or a different first item of ID information relating to the first authentication key and the same or a different second item of ID information relating to the second authentication key are stored on a second memory unit of the second motorized braking apparatus.

20. A method for operating at least one driver braking request sensor together with at least one motorized braking apparatus on and/or in a vehicle, the method comprising the following steps:
ascertaining at least one sensor variable relating to an actuation of a brake actuation element of the vehicle by a driver of the vehicle by a corresponding sensor electronic device of the at least one driver braking request sensor;
outputting at least one sensor signal corresponding to the at least one sensor variable by the corresponding sensor electronic device of the at least one driver braking request sensor to the at least one motorized braking apparatus; and
controlling a corresponding motor of the at least one motorized braking apparatus in each case by a motor control device of the same motorized braking apparatus;
encrypting and/or authenticating the at least one sensor signal by the corresponding sensor electronic device of the at least one driver braking request sensor using at least one authentication key stored on a sensor memory unit of the same driver braking request sensor in such a way that the at least one sensor signal is output to the at least one motorized braking apparatus, in each case as a sensor signal encrypted and/or authenticated with the at least one authentication key;
ascertaining, by the corresponding motor control device of the at least one motorized braking apparatus, taking into account at least one item of ID information stored on a memory unit of the same motorized braking apparatus relating to the at least one authentication key stored on the corresponding sensor memory unit of the at least one driver braking request sensor, of whether at least one signal provided to the corresponding motorized braking apparatus is encrypted and/or authenticated with the at least one authentication key; and
controlling the corresponding motor of the at least one motorized braking apparatus by the motor control device of the same motorized braking apparatus, taking into account the at least one signal provided to the corresponding motorized braking apparatus, only when the at least one provided signal is encrypted and/or authenticated with the at least one authentication key.
